(19) United States
(12) Patent Application Publication
(10) Pub. No.: US 2013/0071534 A1
(43) Pub. Date: Mar. 21, 2013

(54) Grill with Upper Platen Position and Pressure Control

(71) Applicant: Robert K. Newton, Beloit, WI (US)

(72) Inventor: Robert K. Newton, Beloit, WI (US)

(73) Assignee: Carrier Commercial Refrigeration, Inc., Farmington, CT (US)

(21) Appl. No.: 13/581,051

(22) PCT Filed: Apr. 14, 2011
(86) PCT No.: PCT/US11/32451

§ 371 Date: Aug. 24, 2012

Related U.S. Application Data
(60) Provisional application No. 61/347,086, filed on May 21, 2010.

(51) Int. Cl. A47J 37/06; A23L 1/01

(52) U.S. Cl. CPC A47J 37/0611; A23L 1/0128
USPC 426/523; 99/372; 99/349; 99/325

(57) ABSTRACT

An improved grill with an upper platen position and a pressure control is disclosed. The grill may include a lower platen assembly having a lower grilling plate, and an upper platen assembly movably connected to the lower platen assembly. The upper platen assembly may include an upper grilling plate operatively connected to a manipulator capable of applying positive pressure on and adjusting position of the upper grilling plate. Methods of using the grill to cook food items are also disclosed.

### CROSS-REFERENCE TO RELATED APPLICATION

This is an international patent application filed pursuant to the Patent Cooperation Treaty claiming priority under 35 USC § 119(e) to U.S. Provisional Patent Application Ser. No. 61/347,086 filed on May 21, 2010.

### TECHNICAL FIELD OF THE DISCLOSURE

This disclosure generally relates to a grill with an upper platen position and a pressure control to improve the cooking performance of the grill and, more particularly relates to the use of a manipulator to control the position of an upper grilling plate and the pressure applied to the food by the upper grilling plate.

### BACKGROUND OF THE DISCLOSURE

Clamshell grills capable of simultaneously cooking two sides of various food items, such as, hamburger patties, sausage patties, chicken, or other foodstuffs, are known in the art. In particular, clamshell grills are often used in commercial establishments, such as fast-food restaurants, because they reduce the overall cooking time and the amount of operator attention required for cooking. A conventional clamshell grill generally includes an upper platen assembly movably connected to a lower platen assembly. For example, the upper platen assembly may be pivotably coupled to the lower platen assembly for movement between a lower cooking position overlying the lower platen assembly and a raised position inclined upwardly from the lower platen assembly.

When the upper platen assembly is in the lower cooking position, a gap is created between the upper and the lower platen assemblies. This gap is generally adjustable according to the thickness of the foodstuff being cooked. For example, hamburger patties are pre-formed in several different sizes (a quarter pound patty has a greater thickness than a regular patty). To cook the foodstuff (e.g., hamburger patties), an operator selects the gap size and a cooking time via an operator interface for the food item being cooked. The gap size may be selected by a numeric value or by an identification of the food item being cooked.

One problem associated with conventional clamshell grills is their susceptibility to operator errors in selecting the correct gap size out of a menu of twenty or more possible selections according to the wide variety of food items to be cooked by the grill during breakfast, lunch, and dinner. Moreover, conventional clamshell grills cannot accommodate variations in thickness of individual foodstuff, as there is typically only one gap size selection per foodstuff category. For example, four-ounce hamburger patties can vary in thickness from +/−0.15 inches. Because hamburger patties are generally frozen for storage and transportation, the upper cooking platen assembly may rest only on the thickest patty or patties, resulting in uneven cooking of the thinner patties because of delayed contact between the upper platen assembly and thinner patties.

Another problem associated with conventional clamshell grills is that the gap between the upper and lower platen assemblies may need to be adjusted during the cooking operation to accommodate the decrease in size of the foodstuff as it is cooked. For example, hamburger patties often soften and shrink as they are being cooked by the clamshell grill. Thus, it would be desirable to accommodate this change in thickness during the cooking operation. In some instances, the gap may also need to be set so that the hamburger patty is not excessively compressed by the weight of the upper platen to adversely affect the texture and appearance of the cooked patties.

To address the aforementioned problems, clamshell grills with an improved adjustable upper platen assembly have been developed. Specifically, while the movement of the upper platen assembly still relies on the gravity of the upper platen assembly, adjustable platen stops are provided to control the minimum space (the smallest acceptable spacing or gap) between the upper platen assembly and the lower platen assembly during cooking. The platen stops generally need to be manually manipulated to adjust the size of the gap between the upper and the lower platen assemblies.

Another improved clamshell grill uses an adjustable cam coupled to a platen support arm to automatically set the gap between the upper and the lower platen assemblies. However, the cam and its mechanical linkages are exposed to grease and other debris, which may cause malfunction or even complete failure of the cam. Further, the cam is generally incapable of accommodating the variations in thicknesses of the patties.

More recently, a clamshell grill with an improved self-leveling upper platen assembly has been developed. The grill includes a lower platen assembly having a lower grilling surface and a pivotally attached upper platen assembly having an upper grilling surface. The upper platen assembly includes three actuators encased in a shell. A cable attached to each actuator suspends the upper grilling surface. The grill is automatically calibrated to ensure that the upper grilling surface is level. Each actuator independently and sequentially raises the upper grilling surface from the lower grilling surface. When the upper grilling surface lifts from the lower grilling surface, the current in the actuator changes. The settings of each actuator at this instant are stored in a control to determine the calibration point when the upper grilling surface is level. The grill also automatically recognizes a food item placed on the lower grilling surface to determine the cooking parameters of the grill.

However, the three actuators can only control the position of the upper platen assembly through the suspension cable, and are therefore incapable of applying positive pressure to the foodstuff, which may be advantageous in certain cooking processes. Moreover, operation of the actuator/cable self-leveling mechanism may be interrupted by misaligned, entangled, or broken cables, which adds to the maintenance cost of the grill.

Thus, there is a need for a grill that includes upper and lower platen assemblies in which the position of the upper platen assembly can be adjusted with respect to the lower platen assembly to accommodate the foodstuff cooked therebetween. Moreover, there is a need for a grill with adjustable upper platen assembly that is capable of applying positive (i.e., more than gravity) pressure on the foodstuff during cooking. Finally, there is a need for a grill with an adjustable upper platen assembly that is robust in operation and easy to maintain.

### SUMMARY OF THE DISCLOSURE

In one aspect of the present disclosure, an improved grill with upper platen position and pressure control is disclosed. The grill may include a lower platen assembly having a lower grilling plate, and an upper platen assembly movably connected to the lower platen assembly. The upper platen assembly may include an upper grilling plate operatively connected to a manipulator capable of applying pressure on and adjusting position of the upper grilling plate.

In another aspect of the present disclosure, the grill may include a lower platen assembly having a lower grilling plate, and an upper platen assembly movably connected to the lower platen assembly. The upper platen assembly may include an upper grilling plate, a shell, and a parallel manipulator extending between the shell and upper grilling plate.

In yet another aspect of the present disclosure, a method of cooking food on a grill having a fixed lower grilling plate and a movable upper grilling plate operatively connected to a manipulator is disclosed. The method may include the steps of placing the food between the lower and upper grilling plates, actuating the manipulator to place the upper grilling plate into a first position with respect to the lower grilling plate, applying heat to the food through at least one of the lower and upper grilling plates, and actuating the manipulator to apply a first pressure to the food.

Other features of the disclosed apparatus and method of use thereof will be described in greater detail below. It will also be noted here and elsewhere that the apparatus or method disclosed herein may be suitably modified to be used in a wide variety of applications by one of ordinary skill in the art without undue experimentation.

### BRIEF DESCRIPTION OF THE DRAWINGS

For a more complete understanding of the disclosed apparatus and method, reference should be made to the embodiments illustrated in greater detail in the accompanying drawings, wherein:

FIG. 1 is a perspective view of a grill in a lowered position in accordance with this disclosure;

FIG. 2 is a perspective view of a grill in a raised position in accordance with this disclosure;

FIG. 3 is a perspective view of the grill in FIG. 1 with its shell removed, particularly illustrating the manipulator of the upper platen assembly;

FIG. 4 is schematic illustration of one embodiment of the manipulator; and

FIG. 5 is a block diagram of a method for cooking foodstuff using the disclosed grill according to another aspect of this disclosure.

It should be understood that the drawings are not necessarily to scale and that the disclosed embodiments are sometimes illustrated diagrammatically and in partial views. In certain instances, details which are not necessary for an understanding of the disclosed apparatus or method which render other details difficult to perceive may have been omitted. It should be understood, of course, that this disclosure is not limited to the particular embodiments illustrated herein.

### DETAILED DESCRIPTION OF THE DISCLOSURE

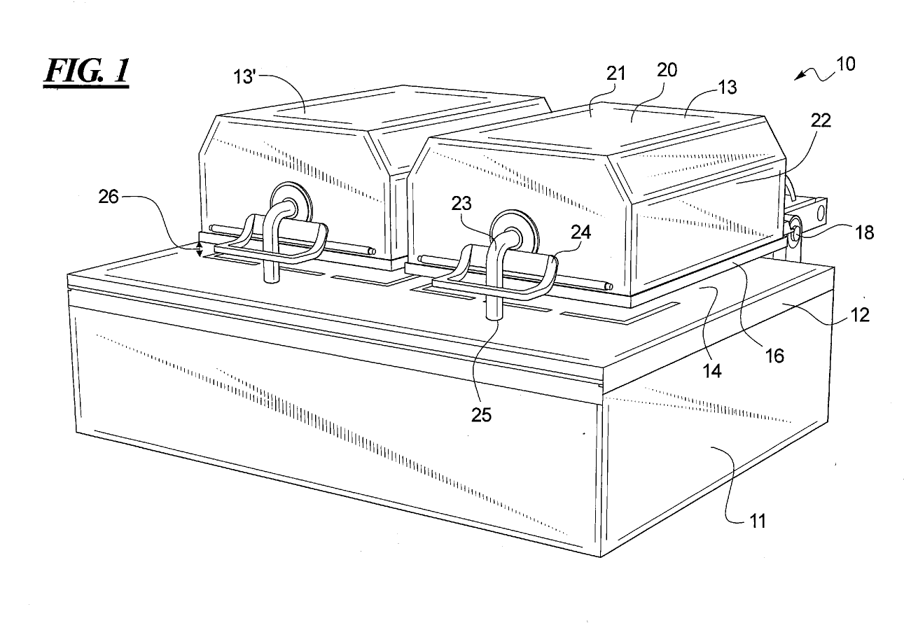

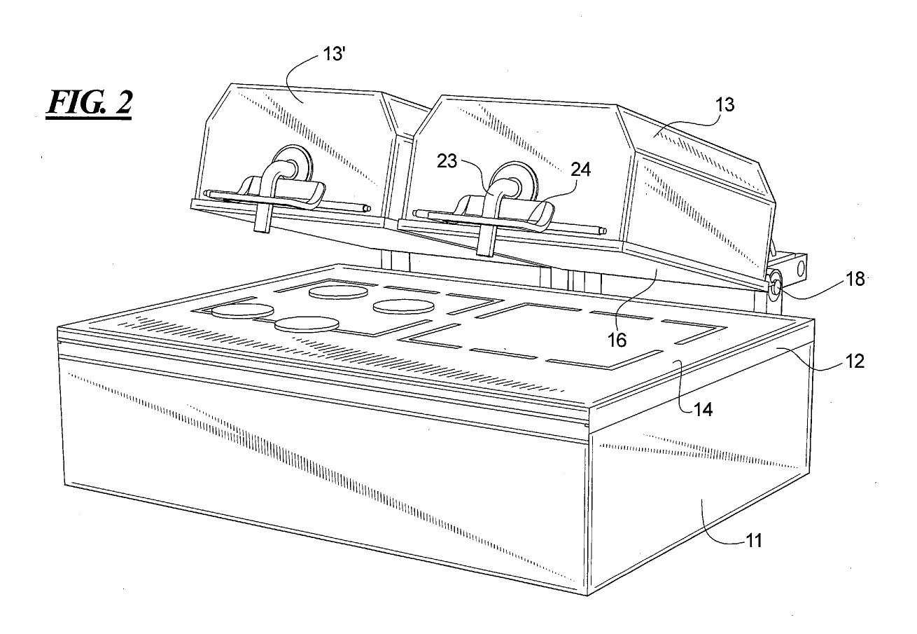

Referring now to FIGS. 1-2, a grill 10 according to the present disclosure is illustrated as having a rigid base structure 11 supporting a lower platen assembly 12 and an upper platen assembly 13. The lower platen assembly 12 may include a lower grilling plate 14 to support food items to be cooked by the grill 10. The lower grilling plate 14 provides heat to the lower side of the food items placed thereon. The upper platen assembly 13 may include an adjustable upper grilling plate 16 to provide heat to the upper side of the food items. In order to transmit heat to the food items cooked by the grill 10, the lower and the upper grilling plates 14 and 16, respectively, may be formed of a heat-conducting material, such as cast aluminum, abrasion-resistant steel, cast iron, stainless steel, mild steel, a ceramic material, or other suitable heat conducting materials used in grills. Although the lower and the upper grilling plates 14 and 16, respectively, are shown in FIGS. 1-2 as having rectangular shapes, one or both of them may also be formed into other shapes such as circular or oval, as well as shape and dimensions of those plates should not be considered as limiting the scope of this disclosure.

As illustrated in FIGS. 1-2, in addition to the upper platen assembly 13 described above, the grill 10 may additionally include another upper platen assembly 13′ positioned in a side-by-side configuration with the upper platen assembly 13. Each of the upper platen assemblies 13 and 13′ may have a width slightly less than one-half of the width of the lower platen assembly 12. Furthermore, the upper platen assemblies 13 and 13′ may be of similar or identical construction or they may be constructed differently to accommodate different cooking tasks. Alternatively, a single upper cooking platen assembly may be used, and the upper platen assemblies 13 and 13′ may assume a wide variety of shapes and sizes.

The upper platen assemblies 13 and 13′ may each be pivotably mounted on a rigid platen support arm 18 for movement between a lower cooking position (FIG. 1) and an upper raised position (FIG. 2). The support arm 18 may be coupled to the base structure 11 or the lower platen assembly 12. Although the upper platen assemblies 13 and 13′ are shown in FIGS. 1-3 to be pivotably movable with respect to the lower platen assembly 12, one or both of the upper platen assemblies may also be horizontally swiveled toward or away from the lower platen assembly. Alternatively, one or both of the upper platen assemblies 13 and 13′ may simply be vertically lowered or raised in a linear motion either manually or through an automated device.

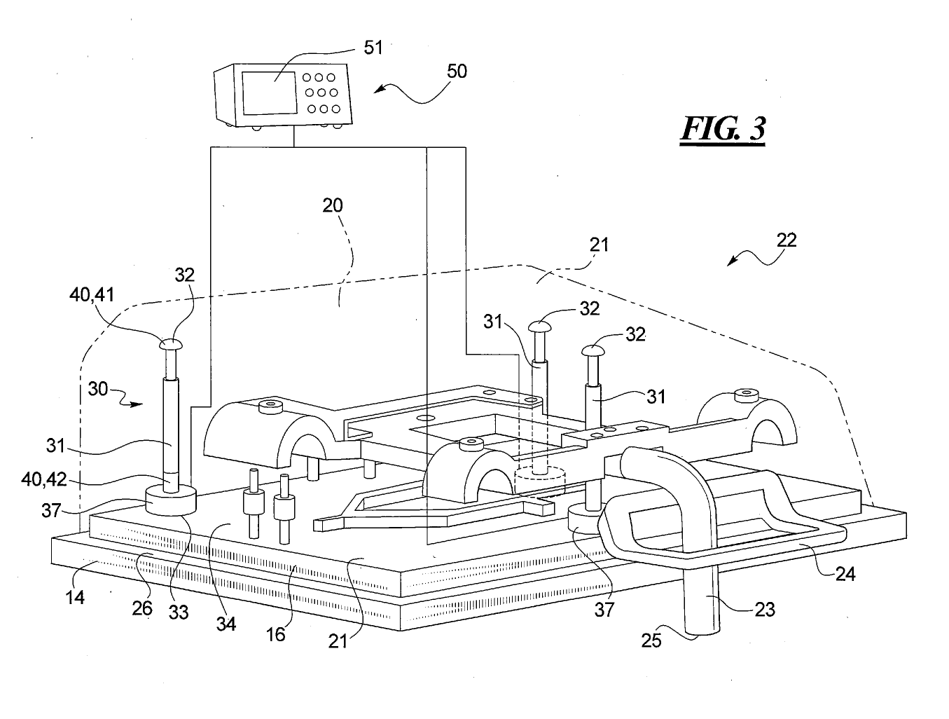

Referring still to FIGS. 1-2 and additionally referring to FIG. 3, the upper platen assemblies 13 and 13′ may be pivotally mounted to the base structure 11 via the support arm 18. The upper platen assemblies 13 and 13′ may additionally include a shell 21, and a manipulator 30 positioned between the upper grilling plate 16 and the shell to adjust the position of and/or apply positive pressure on the upper grilling plate. The shell 21 may substantially overlie the upper grilling plate 16, the combination of which may form a substantially enclosed housing 22. A heater (not shown), such as a gas-burner or an electric heating element, may be disposed in the housing 22 to supply heat to the upper grilling plate 16. Similarly, another heater (not shown) may be included in the lower platen assembly 12 to provide heat to the lower grilling plate 14. Of course, it is to be understood that the type, location and configuration of the heater should not be considered as limiting the scope of this disclosure.

The shell 21 may also include a stop member 23 and a handle 24. The stop member 23 and handle 24 may be integrated into a one-piece construction as illustrated in FIG. 3, or they may be separately provided on the shell 21 (shown only in phantom in FIG. 3). The stop member 23 may have a terminal end 25 that abuts or rests on the lower grilling plate 14 when the upper platen assemblies 13 and 13′ are in the lower cooking position, such as through a downward pivot movement. As illustrated in FIG. 3, such abutment may provide a mechanical stop that may define an initial gap 26 between the lower and the upper grilling plates 14 and 16, respectively. In general, the initially gap 26 is preferably set to be no less that the maximum thickness of the food items placed on the lower grilling plate 14.

As further illustrated in FIG. 3, the upper platen assemblies 13 and 13′ may also include the manipulator 30 to adjust the position of the upper grilling plate 16 and/or to apply positive pressure on the upper grilling plate. The manipulator 30 may be disposed in the housing 22 between the shell 21 and the upper grilling plate 16. In one embodiment, the manipulator 30 may include at least three movable arms 31 extending between the shell 21 and the upper grilling plate 16. As shown in FIG. 3, the at least three movable arms 31 may each have a first end 32 connected to the shell 21 and a second end 33 connected to the upper grilling plate 16. The second ends 33 may be evenly positioned along a peripheral region 34 of the upper grilling plate 16. It is to be understood that the second ends 33 of the at least three movable arms 31 do not necessarily have to be positioned at the edge of the upper grilling plate 16. Rather, one of ordinary skill in the art would understand that the peripheral region 34 encompasses the portion of the upper grilling plate 16 that allows suitable control of the position of the upper grilling plate 16 by the extension or retraction of the at least three movable arms 31.

In order to adjust the position of the upper grilling plate 16 and/or to apply positive pressure on the upper grilling plate 16, each of the at least three movable arms 31 is capable of being independently actuated. To that end, each of the at least three movable arms 31 may include an actuator 37 that operates to extend those arms toward the lower grilling plate 14 or to retract those arms away from the lower grilling plate. The actuators 37 may be hydraulic actuators, pneumatic actuators, mechanical actuators, or combinations thereof.

In the embodiment illustrated in FIG. 3, each of the at least three movable arms 31 are linear and extend or retract longitudinally. Alternatively, the at least three movable arms 31 may each include an upper arm connected to a lower arm through a joint (not shown) and the extension and retraction of the movable arms may be achieved by controlling the joint angle between the upper and lower arms. In any event, through the at least three movable arms 31, the position of the upper grilling plate 16 and/or the initial gap 26 between the lower and the upper grilling plates 14 and 16, respectively, may be adjusted to accommodate the variation of thickness of the food items to be cooked on the grill 10. Moreover, through the at least three movable arms 31, the actuator 37 may apply positive pressure on the upper grilling plate 16, and consequently on the food items as they are being cooked on the grill 10.

In order to monitor the extension and retraction of the at least three movable arms 31 and/or the pressure applied on the upper grilling plate 16, each of those movable arms may be operatively connected to a sensor system 40. The sensor system 40 may include a position sensor 41 to detect the position of each of the at least three movable arms 31. The position sensors 41 may be optical sensors, electrical sensors, electromagnetic sensor, combinations thereof, or other suitable sensors used in automation. The sensor system 40 may also include a pressure sensor 42, such as a strain gauge, that detects the pressure applied on the upper grilling plate 16 through the at least three movable arms 31. The position and the pressure sensors 41 and 42, respectively, may be integrated into a multipurpose sensor or they may be separated as different units. Moreover, the position and the pressure sensors 41 and 42, respectively, may be each or both integrated into the at least three movable arms 31 or they may be positioned elsewhere, such as on the upper grilling plate 16.

To control the extension and retraction of the at least three movable arms 31 and/or the pressure applied on the upper grilling plate 16, the grill 10 may further include a programmable processor 50 in operative connection with the actuator 37 of each of those movable arms. The programmable processor 50 may also be operatively connected to the sensor system 40 to coordinate the movement of the at least three movable arms 31 and the pressure applied on the upper grilling plate 16. Moreover, the programmable processor 50 may be operatively connected to the heater to simultaneously control the temperature of the upper grilling plate.

A user interface 51 may also be provided on the programmable processor 50 to allow the operator to program the application of heat and pressure depending on the food items to be cooked. The user interface 51 may also allow the operator to select among a plurality of pre-programmed heat/pressure applications. The interface 51 may provide a menu of a gap size, temperature, and time selections. Alternatively, the interface 51 may be configured to provide a breakfast, lunch, or dinner menu selection of different food items and the processor 50 automatically determines suitable gap size, temperature, and time for the cooking operation.

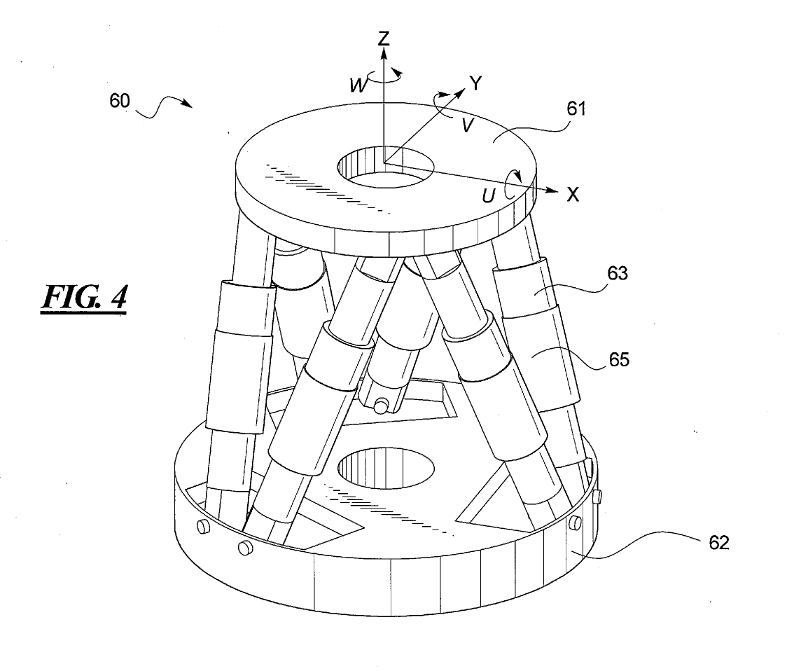

Turning now to FIG. 4, one embodiment of the manipulator 30 is illustrated therein as a parallel manipulator 60. The parallel manipulator 60 illustrated in FIG. 4 is a “Stewart platform” or “hexapod” manipulator. However, it is to be understood that other suitable parallel manipulators, such as Delta manipulators, can also be used. The hexapod manipulator 60 includes a top plate 61, a bottom plate 62, and six struts 63 extending between the top and the bottom plates 61 and 62, respectively. The hexapod manipulator 60 may be mounted in the upper platen assemblies 13 and 13′ by coupling the top plate 61 to the shell 21 and the bottom plate 62 to the upper grilling plate 16. However, it is to be understood that one or both of the respective top and the bottom plates 61 and 62 may be omitted or integrated into the shell 21 or the upper grilling plate 16, in which case the struts 63 may be mounted directly connected to the shell 21 and the upper grilling plate 16.

Each of the struts 63 may be operatively connected to an actuator 65 that extends or retracts the strut 63 and/or applies pressure on the upper grilling plate 16. The struts 63 may be actuated hydraulically, pneumatically, and/or mechanically. In the non-limiting example illustrated in FIG. 4, the struts may be positioned at oblique angles with respect to each other and with respect to the top and the bottom plates 61 and 62, respectively, along the peripheral regions of those plates to form a zig-zag configuration. However, parallel or other configurations of the struts may also be used in other embodiments.

Hexapod manipulators (including its controller) suitable for use in this disclosure may be commercially available. For example, hexapod manipulator systems sold by PI (Physik Instrumente) L.P., 5420 Trabuco Rd., Suite 100, Irvine, Calif. 92620 (http://www.pi-usa.us/).

### INDUSTRIAL APPLICABILITY

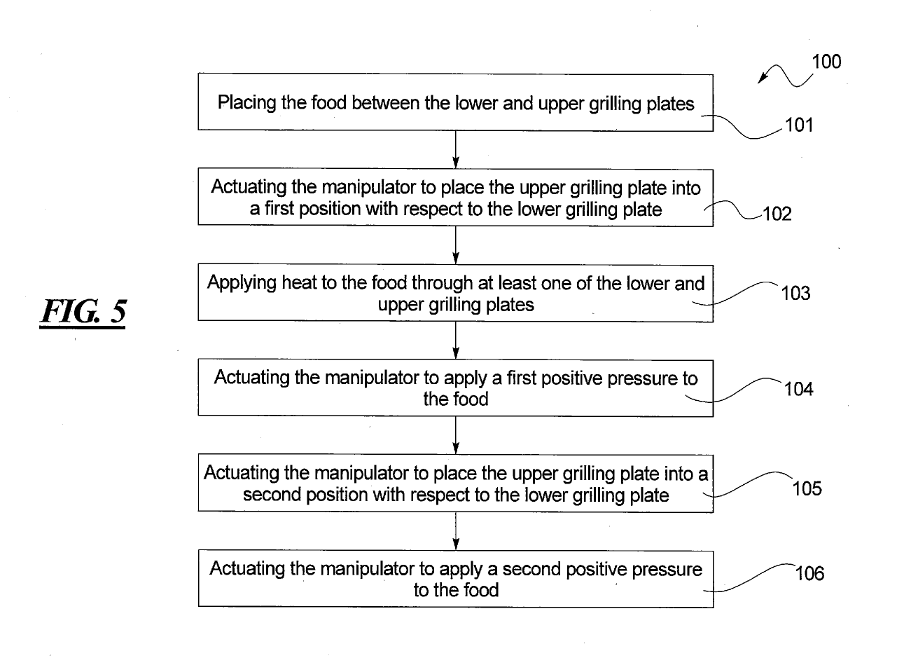

According to another aspect of this disclosure, a method 100 of cooking food on a grill having a fixed lower grilling plate and a movable upper grilling plate operatively connected to a manipulator is disclosed. As schematically illustrated in FIG. 5, the method 100 may include the steps of placing the food between the lower and the upper grilling plates 101, actuating the manipulator to place the upper grilling plate into a first position with respect to the lower grilling plate 102, applying heat to the food through at least one of the lower and the upper grilling plates 103, and actuating the manipulator to apply a first positive pressure to the food 104.

In one embodiment, the method 100 may further include an optional step 105 of actuating the manipulator to place the upper grilling plate into a second position with respect to the lower grilling plate. In another embodiment, the method 100 may further include an optional step 106 of actuating the manipulator to apply a second positive pressure to the food.

While only certain embodiments have been set forth, alternative embodiments and various modifications will be apparent from the above descriptions to those skilled in the art. These and other alternatives are considered equivalents and within the spirit and scope of this disclosure.

1. A grill, comprising:
a lower platen assembly having a lower grilling plate; and
an upper platen assembly movably connected to the lower platen assembly, the upper platen assembly comprising an upper grilling plate operatively connected to a manipulator, the manipulator capable of applying positive pressure on and adjusting position of the upper grilling plate.

2. The grill of claim 1, wherein the manipulator is disposed between the upper grilling plate and a shell overlying the upper grilling plate.

3. The grill of claim 2, wherein the manipulator comprises at least three movable arms extending between the shell and the upper grilling plate.

4. The grill of claim 3, wherein the at least three movable arms are evenly positioned along a peripheral region of the upper grilling plate.

5. The grill of claim 3, wherein each of the at least three movable arms is independently actuated.

6. The grill of claim 5, wherein each of the at least three movable arms comprises an actuator that extends or retracts the respective one of the at least three movable arms.

7. The grill of claim 6, wherein each of the actuators is capable of applying a positive pressure on the upper grilling plate through the respective one of the at least three movable arms.

8. The grill of claim 7, further comprising a sensor system that detects positions of the upper grilling plate.

9. The grill of claim 8, wherein the sensor system detects the positive pressure applied on the upper grilling plate through the at least three movable arms.

10. The grill of claim 9, further comprising a programmable processor in operative connection with the actuator of each of the at least three movable arms.

11. The grill of claim 10, wherein the programmable processor is in operative connection with the sensor system.

12. A grill, comprising:
a lower platen assembly having a lower grilling plate; and
an upper platen assembly movably connected to the lower platen assembly, the upper platen assembly comprising an upper grilling plate, a shell, and a parallel manipulator extending between the shell and upper grilling plate.

13. The grill of claim 12, further comprising a sensor system that detects the position of the upper grilling plate.

14. The grill of claim 13, wherein the sensor system detects pressure applied on the upper grilling plate by the parallel manipulator.

15. The grill of claim 14, further comprising a programmable processor in operative connection with the parallel manipulator.

16. The grill of claim 15, wherein the programmable processor is in operative connection with the sensor system.

17. A method of cooking food on a grill having a fixed lower grilling plate and a movable upper grilling plate operatively connected to a manipulator, the method comprising, placing the food between the lower and the upper grilling plates;
actuating the manipulator to place the upper grilling plate into a first position with respect to the lower grilling plate;
applying heat to the food through at least one of the lower and the upper grilling plates; and
actuating the manipulator to apply a first positive pressure to the food.

18. The method of claim 17, further comprising actuating the manipulator to place the upper grilling plate into a second position with respect to the lower grilling plate.

19. The method of claim 18, further comprising actuating the manipulator to apply a second positive pressure to the food.

20. The method of claim 19, wherein the manipulator is operatively connected to a programmable processor to control the position of the upper grilling plate and the positive pressure applied on the food.
